(19) United States
(12) Patent Application Publication
(10) Pub. No.: US 2025/0110650 A1
(43) Pub. Date: Apr. 3, 2025

(54) ORPHAN BUCKET SCANNER

(71) Applicant: Google LLC, Mountain View, CA (US)

(72) Inventors: Alankrit Kharbanda, Seattle, WA (US); Joshua Sosa, Durham, NC (US); Xiangqian Yu, Fremont, CA (US)

(73) Assignee: Google LLC, Mountain View, CA (US)

(21) Appl. No.: 18/477,523

(22) Filed: Sep. 28, 2023

(51) Int. Cl. G06F 3/06

(52) U.S. Cl. CPC G06F 3/0631; G06F 3/0604; G06F 3/0673

(57) ABSTRACT

A method for an orphan bucket scanner includes obtaining a directory including a plurality of storage buckets deployed in a container-based environment. The method includes for each respective storage bucket of the plurality of storage buckets, identifying a resource associated with the respective storage bucket of the plurality of storage buckets. The method also includes for at least one storage bucket from the plurality of storage buckets determining that the resource has been deleted from the container-based environment and adding the at least one storage bucket corresponding to the deleted resource to a subset of storage buckets. The method also includes generating an alert including the subset of storage buckets.

### TECHNICAL FIELD

This disclosure relates to an orphan bucket scanner.

### BACKGROUND

A container includes software that packages code and corresponding dependencies such that the container can execute applications quickly and reliably from one computing environment to another. In this way, containers virtualize the operating system and can run in any environment, from a private data center to a public cloud. A container-based environment deploys numerous containers across multiple computing clusters to execute various workloads. Each container is generally allocated storage which may be divided into one or more storage buckets. A resource of the container points to the storage buckets as a virtual mapping of the allocated storage.

### SUMMARY

One aspect of the disclosure provides a computer-implemented method for an orphan bucket scanner. The computer-implemented method is executed by data processing hardware that causes the data processing hardware to perform operations including obtaining a directory including a plurality of storage buckets deployed in a container-based environment. The operations include, for each respective storage bucket of the plurality of storage buckets, identifying a resource associated with the respective storage bucket of the plurality of storage buckets. The operations further include, for at least one storage bucket from the plurality of storage buckets determining that the resource associated with the at least one storage bucket from the plurality of storage buckets has been deleted from the container-based environment and, in response to determining that the resource associated with the at least one storage bucket from the plurality of storage buckets has been deleted from the container-based environment, adding the at least one storage bucket from the plurality of storage buckets to a subset of storage buckets from the plurality of storage buckets. The operations further include generating an alert including the subset of storage buckets.

Implementations of the disclosure may include one or more of the following optional features. In some implementations, the operations further include deleting each storage bucket of the subset of storage buckets from the plurality of storage buckets from the container-based environment. The alert may include a user-interface listing each storage bucket of the subset of storage buckets from the plurality of storage buckets.

In some implementations, identifying the resource associated with the respective storage bucket of the plurality of storage buckets includes identifying a prefix associated with the respective storage bucket of the plurality of storage buckets. These implementations include identifying the resource associated with the identified prefix associated with the respective storage bucket of the plurality of storage buckets. In these implementations, the prefix may be a unique identification number comprising a fixed number of alphanumeric characters.

In some implementations, the operations include periodically obtaining a new directory comprising a new plurality of storage buckets deployed in the container-based environment and identifying a new subset of storage buckets from the new plurality of storage buckets that correspond to respective resources that have been deleted from the container-based environment. The container-based environment may include an air-gapped environment that is not connected to the Internet. The air-gapped environment may include a plurality of edge devices communicatively coupled through a network of the air-gapped environment. Further, each storage bucket of the subset of storage buckets from the plurality of storage buckets may not be reconnected to a new resource of the container-based environment.

Another aspect of the disclosure provides a system for an orphan bucket scanner. The system includes data processing hardware and memory hardware in communication with the data processing hardware. The memory hardware stores instructions that when executed on the data processing hardware cause the data processing hardware to perform operations. The operations include obtaining a directory including a plurality of storage buckets deployed in a container-based environment. The operations include, for each respective storage bucket of the plurality of storage buckets, identifying a resource associated with the respective storage bucket of the plurality of storage buckets. The operations further include, for at least one storage bucket from the plurality of storage buckets determining that the resource associated with the at least one storage bucket from the plurality of storage buckets has been deleted from the container-based environment and, in response to determining that the resource associated with the at least one storage bucket from the plurality of storage buckets has been deleted from the container-based environment, adding the at least one storage bucket from the plurality of storage buckets to a subset of storage buckets from the plurality of storage buckets. The operations further include generating an alert including the subset of storage buckets.

This aspect may include one or more of the following optional features. In some implementations, the operations further include deleting each storage bucket of the subset of storage buckets from the plurality of storage buckets from the container-based environment. The alert may include a user-interface listing each storage bucket of the subset of storage buckets from the plurality of storage buckets.

In some implementations, identifying the resource associated with the respective storage bucket of the plurality of storage buckets includes identifying a prefix associated with the respective storage bucket of the plurality of storage buckets. These implementations include identifying the resource associated with the identified prefix associated with the respective storage bucket of the plurality of storage buckets. In these implementations, the prefix may be a unique identification number comprising a fixed number of alphanumeric characters.

In some implementations, the operations include periodically obtaining a new directory comprising a new plurality of storage buckets deployed in the container-based environment and identifying a new subset of storage buckets from the new plurality of storage buckets that correspond to respective resources that have been deleted from the container-based environment. The container-based environment may include an air-gapped environment that is not connected to the Internet. The air-gapped environment may include a plurality of edge devices communicatively coupled through a network of the air-gapped environment. Further, each storage bucket of the subset of storage buckets from the plurality of storage buckets may not be reconnected to a new resource of the container-based environment.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for an orphan bucket scanner.

FIG. 2 is a schematic view of an example resource in a container-based environment pointing to various storage buckets.

FIG. 3 is a sequence diagram illustrating sequential interactions of various components of the system of FIG. 1 for executing an orphan bucket scanner.

FIG. 4 is a flowchart of an example arrangement of operations for a method of an orphan bucket scanner.

FIG. 5 is a schematic view of an example computing device that may be used to implement the systems and methods described herein.

Like reference symbols in the various drawings indicate like elements.

### DETAILED DESCRIPTION

In a container-based environment, each container is allocated memory, which may correspond to physical memory on a disk. The container may divide the allocated memory into one or more storage buckets. A storage bucket is a way to store data, but unlike a folder or directory, the storage buckets cannot be nested. Here, the container may include a resource (such as a namespace) that points to each storage bucket, effectively mapping the storage buckets of the container. Typically these resources are expected to be protected from deletion, and thus the mapping to the storage buckets to remain intact. However, a forced deletion of a resource can leave the corresponding buckets “orphaned” (i.e., there is no resource pointing to the storage bucket). Once a storage bucket is orphaned it cannot be reconnected to the container-based environment.

Implementations herein are directed to an orphan bucket scanner to detect orphaned buckets in a container-based environment (i.e., a container orchestration system). The orphan bucket scanner may continuously or periodically identify storage buckets stored in the container-based environment. The orphan bucket scanner may then identify a corresponding resource for each storage bucket. When the corresponding resource is still active, then the storage bucket is still in use. However, when the corresponding resource has been deleted, each corresponding storage bucket of that resource is considered orphaned. The orphan bucket scanner may then delete the orphaned buckets or generate an alert for a user of the system identifying the orphaned buckets.

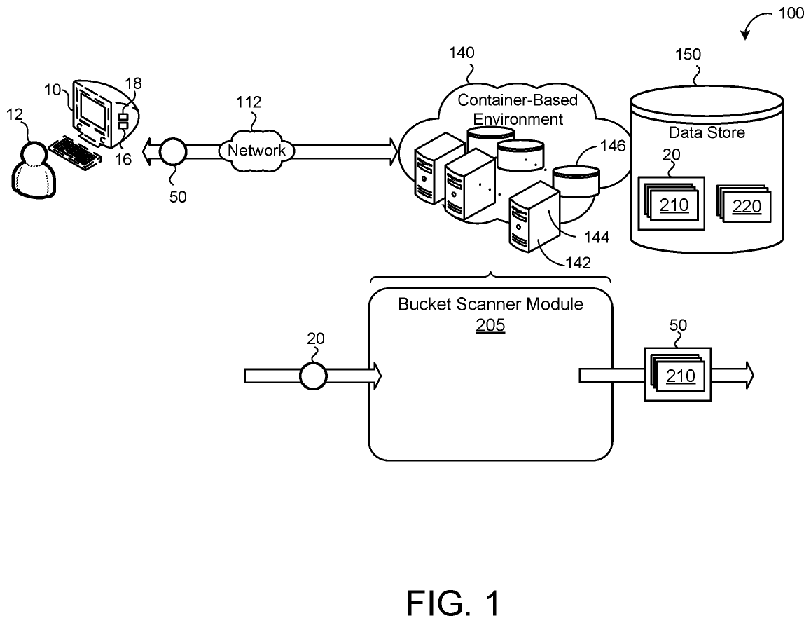

Referring to FIG. 1, in some implementations, an orphan bucket scanner system 100 includes a container-based environment 140 (e.g., a high-performance remote server or cluster of high-performance remote servers) in communication with one or more client devices 10 via a network 112. The client device 10 may correspond to any computing device, such as a desktop workstation, a laptop workstation, or a mobile device (i.e., a smart phone). The client device 10 includes computing resources 18 (e.g., data processing hardware) and/or storage resources 16 (e.g., memory hardware). The container-based environment may be a cloud environment that is accessible by one more devices through the Internet. In some implementations, the container-based environment is a self-contained air-gapped environment that is not connected to the Internet. Here, the client device 10 may be an edge device (i.e., an appliance) of the air-gapped environment that is connected to a network 112 that is a wired or wireless connection that is not accessible by devices outside of the air-gapped environment.

The container-based environment 140 (i.e., a cloud environment hosting multiple containers, such as for a container orchestration system) may be a single computer, multiple computers, or a distributed system having scalable/elastic resources 142 including computing resources 144 (e.g., data processing hardware) and/or storage resources 146 (e.g., memory hardware). The container-based environment 140 may be configured to execute a bucket scanner module 205 for identifying storage buckets 210 that are orphaned (i.e., associated with a deleted resource 220). A data store 150 (i.e., a remote storage device) may be overlain on the storage resources 146 to allow scalable use of the storage resources 146 by one or more of the clients (e.g., the client device 10) or the computing resources 144 (e.g., the bucket scanner module 205). The data store 150 is configured to store a directory 20 including one or more storage buckets 210 and one or more resources 220 (or an identity of each of one or more active resources 220).

The container-based environment 140 executes a bucket scanner module 205 for identifying one or more storage buckets 210 that are orphaned. Bucket scanner module 205 may obtain the directory 20 listing each storage bucket 210 of the container-based system (i.e., each storage bucket 210 stored at the data store 150). In some implementations, the bucket scanner module 205 may identify a corresponding resource 220 for each storage bucket 210. In these implementations, the bucket scanner module 205 may identify the corresponding resource 220 of each storage bucket 210 by identifying a prefix associated with the respective storage bucket 210, and identifying the corresponding resource 220 based on the prefix. For example, a storage bucket 210 may be named “abcde.Bucket1.” In this example, the prefix “abcde” may identify the resource 220 associated with the bucket 210. In some implementations the prefix may be a unique identification number having a fixed number of digits and/or alphanumeric characters.

The bucket scanner module 205 may then identify which resources 220 are active and which resources 220 have been deleted. The bucket scanner module 205 may then add each storage bucket 210 corresponding to a deleted resource 220 to a subset of storage buckets 210 (i.e., a set of orphaned storage buckets). In some implementations, the bucket scanner module 205 deletes the storage buckets 210 of the subset of storage buckets 210. In other implementations, the bucket scanner module 205 generates an alert 50 including a list of each storage bucket 210 of the subset of storage buckets 210 (i.e., a listing of all of the orphaned storage buckets 210 stored at the data store 150 of the container-based environment 140).

The system 100 of FIG. 1 is presented for illustrative purposes only and is not intended to be limiting. For example, although only a single example of each component is illustrated, the system 100 includes any number of components 10, 140, 150, and 205. Further, although some components are described as being located in the container-based environment 140, in some implementations, some or all of the components may be hosted locally on the client device 10. Further, in various implementations, some or all of the components 150 and 205, are hosted locally on client device 10, remotely (such as in the container-based environment 140), or some combination thereof.

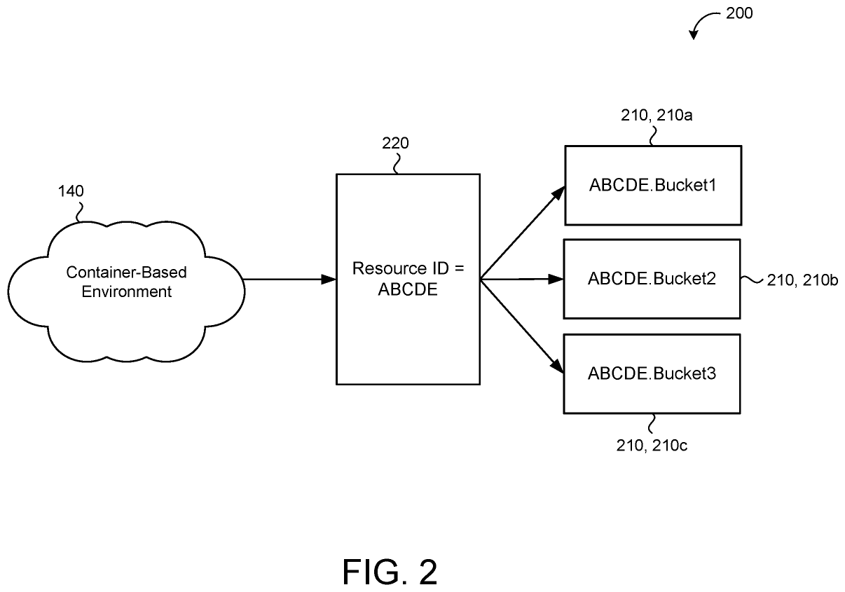

FIG. 2 is a schematic view 200 of an example resource 220 in a container-based environment 140 pointing to various storage buckets 210, 210a-c. Here, the example resource 220 (e.g., a namespace) points to three storage buckets 210a-c. The resource 220 has a unique identifier “ABCDE” which is also included as a prefix to the name of each storage bucket 210a-c. In particular, the first storage bucket 210, 210a is named “ABCDE.Bucket1,” the second storage bucket 210, 210b is named “ABCDE.Bucket2,” and the third storage bucket 210, 210c is named “ABCDE.Bucket3.” In some implementations, the unique identifier of the resource 220 is not reproducible. In these implementations, if the resource 220 is deleted, the container-based environment 140 would not be able to add a new resource 220 having the same unique ID. Accordingly, if the resource 220 is deleted, the corresponding storage buckets 210a-c become abandoned as no other resource 220 in the container-based environment 140 can be connected to the storage bucket. However, if a storage bucket 210 is deleted, a new storage bucket 210 may be able to be named after the deleted storage bucket 210 and then take over the previous connection to the resource 220. For example, if storage bucket 210a is deleted, the container-based environment 140 may add a new storage bucket 210 with the name “ABCDE.Bucket1,” resulting in the new storage bucket 210 taking over the connection to the resource 220 previously occupied by storage bucket 210a.

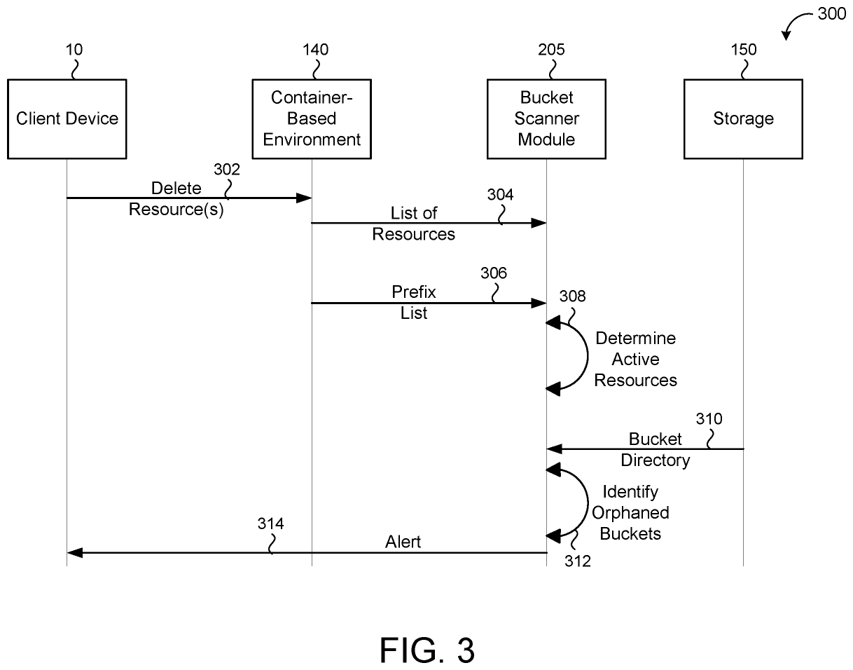

FIG. 3 illustrates a sequence diagram 300 illustrating sequential interactions of various components 10, 140, 205, 150, of the system 100 of FIG. 1 for executing an orphan bucket scanner. At step 302, the client device 10 may delete one or more resources 220 from the container-based environment 140, effectively orphaning one or more storage buckets 210. The bucket scanner module 205 may then periodically or continuously scan the container-based environment for orphaned storage buckets 210. At step 304 and 306, the bucket scanner module 205 may obtain a list or resources 220 and a prefix list indicating all of the unique identifiers that have been assigned to resources 220. At step 308, the bucket scanner module 205 may identify active resources 220 by comparing the list of resources 220 to the prefix list. At step 310, the bucket scanner module 205 obtains a directory 20 listing all of the storage buckets 210 in the data store 150. The bucket scanner module 205 may then, for each storage bucket 210, identify a prefix associated with the storage bucket. At step 312, the bucket scanner module 205 may identify orphaned storage buckets 210 by comparing the identified prefixes of the storage buckets 210 of the directory 20 to the active resources 220. When the bucket scanner module 205 determines that the prefix matches an active resource 220, the respective storage bucket 210 is active. When the bucket scanner module 205 is not able to match the prefix to an active resource 220 the respective storage bucket 210 is an orphan. Accordingly, the bucket scanner module 205 may add the orphaned storage bucket 210 to a list of orphaned storage buckets 210 (i.e., a subset of the storage buckets 210). At step 314, the bucket scanner module 205 transmits an alert to the client device indicating the list of orphaned storage buckets 210. In some implementations, the bucket scanner module 205 deletes the orphaned storage buckets 210 to preserve disk space in the container-based environment 140. The system 100 may repeat steps 302-314 continuously or periodically to identify new orphaned storage buckets 210.

The above example is for illustrative purposes only and is not intended to be limiting. For example, the components 10, 140, 205, and 150 may be merged or divided into further components to execute the various steps of the sequence diagram 300. Further, some of the steps 302-314 may be executed by a different component and not as illustrated in the sequence diagram 300. For example, the container-based environment 140 may maintain a list of active resources 220. Accordingly, the bucket scanner module 205 could simply obtain or retrieve the list of active resources 220 instead of determining the active resources 220.

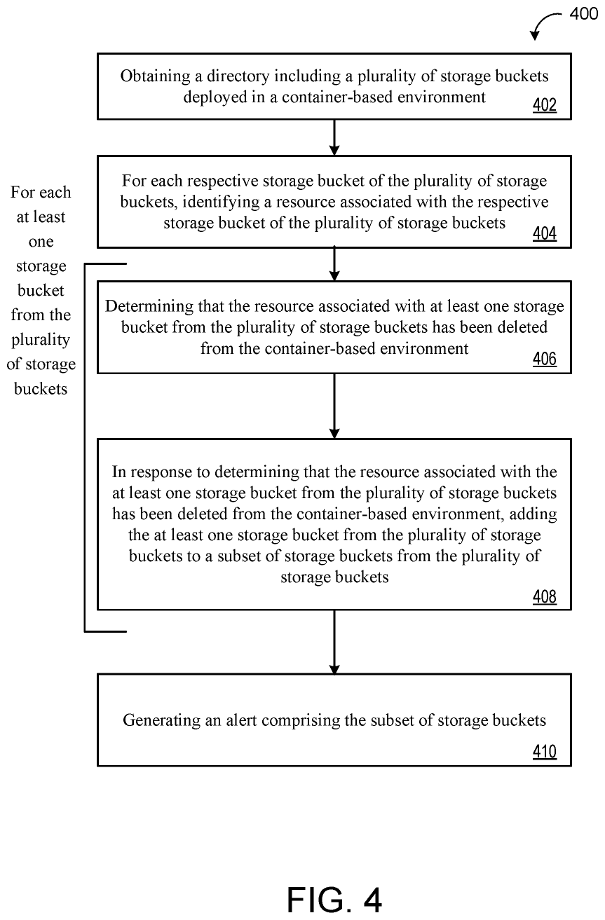

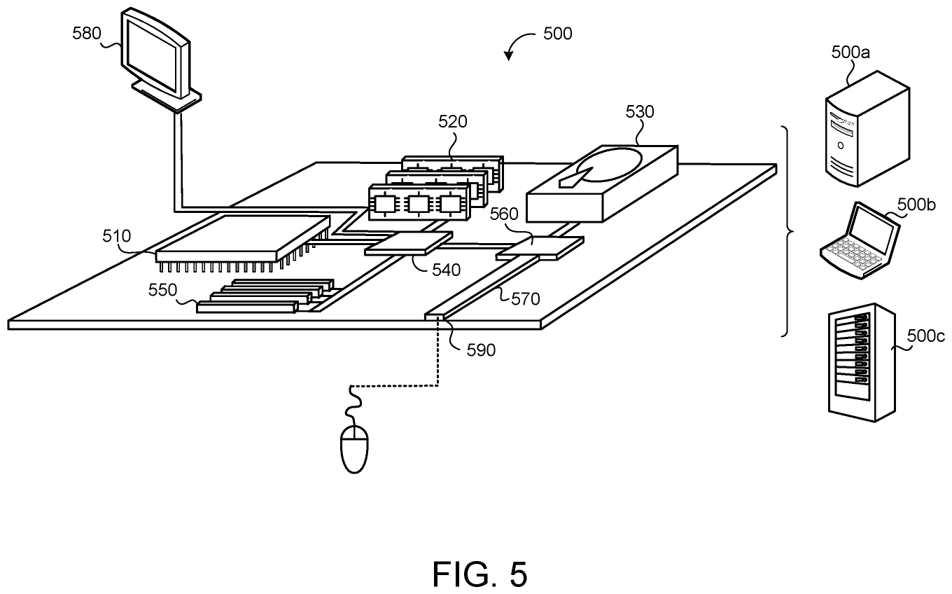

FIG. 4 is a flowchart of an exemplary arrangement of operations for a method 400 of an orphan bucket scanner. The method 400 can be performed by various interconnected computing devices of a computing system, such as the components of the system 100 of FIG. 1 and/or the computing device 500 of FIG. 5. At operation 402, the method 400 includes obtaining a directory 20 including a plurality of storage buckets 210 deployed in a container-based environment 140. At operation 404, the method 400 includes for each respective storage bucket 210 of the plurality of storage buckets 210, identifying a resource 220 associated with the respective storage bucket 210 of the plurality of storage buckets 210. For at least one storage bucket 210 from the plurality of storage buckets 210, the method 400 includes operations 406 and 408. At operation 406, the method 400 includes determining that the resource 220 associated with the at least one storage bucket 210 from the plurality of storage buckets 210 has been deleted from the container-based environment 140. At operation 408, the method 400 includes in response to determining that the resource 220 associated with the at least one storage bucket 210 from the plurality of storage buckets 210 has been deleted from the container-based environment 140, adding the rat least one storage bucket 210 from the plurality of storage buckets 210 to a subset of storage buckets 210 from the plurality of storage buckets 210. At operation 410, the method 400 includes generating an alert 50 including the subset of storage buckets 210.

FIG. 5 is a schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

1. A computer-implemented method executed by data processing hardware that causes the data processing hardware to perform operations comprising:
obtaining a directory comprising a plurality of storage buckets deployed in a container-based environment;
for each respective storage bucket of the plurality of storage buckets:
identifying a prefix associated with the respective storage bucket of the plurality of storage buckets; and
identifying, based on the prefix associated with the respective storage bucket, a resource associated with the respective storage bucket of the plurality of storage buckets;
for at least one storage bucket from the plurality of storage buckets:
determining that the resource associated with the at least one storage bucket from the plurality of storage buckets has been deleted from the container-based environment; and
in response to determining that the resource associated with the at least one storage bucket from the plurality of storage buckets has been deleted from the container-based environment, adding the at least one storage bucket from the plurality of storage buckets to a subset of storage buckets from the plurality of storage buckets; and
generating an alert comprising the subset of storage buckets.

2. The method of claim 1, wherein the operations further comprise deleting each storage bucket of the subset of storage buckets from the plurality of storage buckets from the container-based environment.

3. The method of claim 1, wherein the alert comprises a user-interface listing each storage bucket of the subset of storage buckets.

4. (canceled)

5. The method of claim 1, wherein the prefix is a unique identification number comprising a fixed number of alphanumeric characters.

6. The method of claim 1, wherein the operations further comprise:
periodically obtaining a new directory comprising a new plurality of storage buckets deployed in the container-based environment; and
identifying a new subset of storage buckets from the new plurality of storage buckets that correspond to respective resources that have been deleted from the container-based environment.

7. The method of claim 1, wherein the container-based environment comprises an air-gapped environment that is not connected to the Internet.

8. The method of claim 7, wherein the air-gapped environment comprises a plurality of edge devices communicatively coupled through a network of the air-gapped environment.

9. The method of claim 1, wherein the plurality of storage buckets are stored at a data store of the container-based environment.

10. The method of claim 1, wherein each storage bucket of the subset of storage buckets cannot be reconnected to a new resource of the container-based environment.

11. A system comprising:
data processing hardware; and
memory hardware in communication with the data processing hardware, the memory hardware storing instructions that when executed on the data processing hardware cause the data processing hardware to perform operations comprising:
obtaining a directory comprising a plurality of storage buckets deployed in a container-based environment;
for each respective storage bucket of the plurality of storage buckets:
identifying a prefix associated with the respective storage bucket of the plurality of storage buckets; and
identifying, based on the prefix associated with the respective storage bucket, a resource associated with the respective storage bucket of the plurality of storage buckets;
for at least one storage bucket from the plurality of storage buckets:
determining that the resource associated with the at least one storage bucket from the plurality of storage buckets has been deleted from the container-based environment; and
in response to determining that the resource associated with the at least one storage bucket from the plurality of storage buckets has been deleted from the container-based environment, adding the at least one storage bucket from the plurality of storage buckets to a subset of storage buckets from the plurality of storage buckets; and
generating an alert comprising the subset of storage buckets.

12. The system of claim 11, wherein the operations further comprise deleting each storage bucket of the subset of storage buckets from the plurality of storage buckets from the container-based environment.

13. The system of claim 11, wherein the alert comprises a user-interface listing each storage bucket of the subset of storage buckets.

14. (canceled)

15. The system of claim 11, wherein the prefix is a unique identification number comprising a fixed number of alphanumeric characters.

16. The system of claim 11, wherein the operations further comprise:
periodically obtaining a new directory comprising a new plurality of storage buckets deployed in the container-based environment; and
identifying a new subset of storage buckets from the new plurality of storage buckets that correspond to respective resources that have been deleted from the container-based environment.

17. The system of claim 11, wherein the container-based environment comprises an air-gapped environment that is not connected to the Internet.

18. The system of claim 17, wherein the air-gapped environment comprises a plurality of edge devices communicatively coupled through a network of the air-gapped environment.

19. The system of claim 11, wherein the plurality of storage buckets are stored at a data store of the container-based environment.

20. The system of claim 11, wherein each storage bucket of the subset of storage buckets cannot be reconnected to a new resource of the container-based environment.
